(19) United States
(12) Patent Application Publication
(10) Pub. No.: US 2002/0116307 A1
(43) Pub. Date: Aug. 22, 2002

(54) Banner advertising on truck bodies business method

(76) Inventors: Paul J. Britten, Traverse City, MI (US); Jon J. Lapekas, Traverse City, MI (US)

Correspondence Address: HARNESS, DICKEY & PIERCE, P.L.C., P.O. BOX 828, BLOOMFIELD HILLS, MI, 48303, US

(21) Appl. No.: 09/835,688

(22) Filed: Apr. 16, 2001

Related U.S. Application Data
(60) Provisional application No. 60/270,701, filed on Feb. 22, 2001.

(51) Int. Cl. G06F 17/60

(52) U.S. Cl. 705/35

(57) ABSTRACT

In a method according to this invention, a manufacturer of truck bodies manufactures the truck bodies with mounting hardware for the banners. The manufacturer then receives a share of revenues from sales of banners to be affixed to truck bodies made by the manufacturer with the mounting hardware for the banners. In another embodiment of the invention, a virtual marketplace provides for the owners of truck bodies with the banner mounting hardware to register their truck bodies if they are willing to allow banner advertisements to be placed on their truck bodies. Media buyers can then access the database to determine what truck bodies have been made available for banner advertising.

### FIELD OF THE INVENTION

The present invention relates advertising on sides of trucks, and more particularly, to advertising on the sides of trucks where the advertisement is in the form of a banner that is affixed to the side of the truck.

### BACKGROUND OF THE INVENTION

In recent years, changeable truck-side advertising or “rolling-billboards” has become available. This concept originated in the mid-1990's following the introduction of superwide, direct-to-media digital printing devices. Until this time, advertisements or other displays on the sides of truck bodies or vans were typically hand painted images, pressure-sensitive computer-cut images and/or pressure-sensitive decals. The term “truck body” will be used herein to refer to truck bodies that are integral with the truck tractor, such as is usually the case for medium duty commercial trucks, and vans which are coupled to truck tractors, such as is usually the case for heavy duty commercial trucks, particularly, those used to transport freight long distances.

The introduction of superwide printing technology allowed printers to provide seamless, durable prints, termed “banner” herein, on industrial fabrics up to sixteen feet wide by fifty-four feet long. At about the same time, various hardware systems were developed to securely attach the banners to the side of a truck body in such a manner that the banner could be tensioned and able to withstand the extended exposure to the winds resulting from expressway travel.

The developers/sellers of these hardware systems developed various marketing schemes to sell their hardware systems, including selling them to the banner printers, to the truck body or van owners, to agencies, and the like. Various agencies emerged that began specializing in the sales of this new media and to broker deals between truck body owners, hardware developers/sellers, printers, installers and advertisers.

FIG. 1 illustrates a typical existing arrangement for the placement of banner advertising on truck bodies. An agent 10 brokers a deal with an advertising agency 12 to place an advertisement prepared by the advertising agency 12 for an advertising client 16 on the side of a truck owned by truck body owner 14. The advertising agency 12 is compensated by its advertising client for the preparation of the advertisement and, in many cases, receives a percentage of the media buy, that is, the amount spent to run or display the advertisement, which is also paid by the advertising client 16. In the case of advertising on sides of trucks, the media buy is the purchase of the right to place the advertisement on the side of the truck and would be paid to truck body owner 14. The agent 10 also receives a percentage of the media buy.

The agent 10 may also have brokered a deal between advertising agency 12 and printer 18 to print the banner advertisement that will be placed on the truck body owned by truck body owner 14. The advertising agency 12 would pay printer 18 for the cost of printing the banner advertisement and would in turn bill this cost to its advertising client 16, usually adding its own commission as well as a commission charged by agent 10 to this bill. Alternatively, agent 10 may be paid a commission by printer 18, which would be included in the cost of the banner advertisement charged by printer 18.

Hardware manufacturer 20 makes the hardware required to affix the banner advertisements to the truck body sides and sells them to printer 18, truck body owner 14, and/or agent 10. In this regard, hardware manufacturer may sell the hardware directly to printer 18 and truck body owner 14, have the deal brokered by agent 10, or sell the hardware to agent 10 for resale to printer 18 and truck body owner 14.

It is an object of this invention to provide a business method that links the printers or sellers of banners with truck body manufacturers who receive a share of revenue from the printing or sales of the banners in return for manufacturing the truck bodies with the hardware needed to affix the banners to the sides of the truck bodies.

It is another object of this invention to provide a virtual marketplace for truck body advertising that facilitates the placement of banner advertisements on truck bodies.

### SUMMARY OF THE INVENTION

In a method according to this invention, a manufacturer of truck bodies manufactures the truck bodies with mounting hardware for the banners. The manufacturer then receives a share of revenues from sales of banners to be affixed to truck bodies made by the manufacturer with the mounting hardware for the banners. In an embodiment, the manufacturer receives a shares of revenues that the printer of the banners receives from the printing of the banners to be affixed to the side of the truck bodies that the manufacture manufactured with the banner mounting hardware.

In another embodiment of the invention, a virtual marketplace provides for the owners of truck bodies with the banner mounting hardware to register their truck bodies if they are willing to allow banner advertisements to be placed on their truck bodies. Media buyers can then access the database to determine what truck bodies have been made available by their owners for banner advertising, select the truck bodies on which they wish to place banner advertising, and place orders to do so.

Further areas of applicability of the present invention will become apparent from the detailed description provided hereinafter. It should be understood that the detailed description and specific examples, while indicating the preferred embodiment of the invention, are intended for purposes of illustration only and are not intended to limited the scope of the invention.

### BRIEF DESCRIPTION OF THE DRAWINGS

The present invention will become more fully understood from the detailed description and the accompanying drawings, wherein:

FIG. 1 is a diagrammatic illustration of a prior art business model for banner advertising on truck bodies;

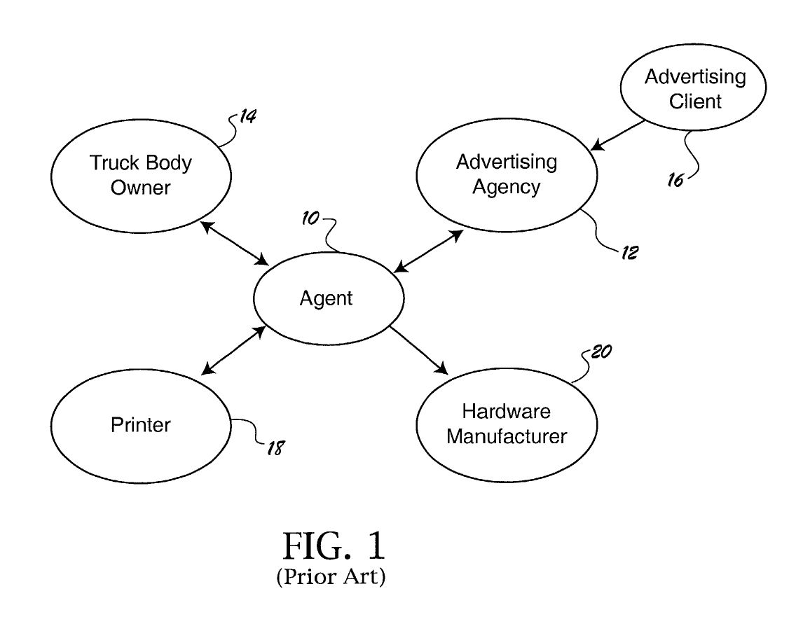

FIG. 2 is a diagrammatic illustration of the business method for banner advertising on truck bodies in accordance with this invention;

FIG. 3 is a variation of the method of FIG. 2;

FIG. 4 is a block diagram of a virtual marketplace system for implementing the truck body virtual banner advertising marketplace in accordance with this invention; and

FIG. 5 is a block diagram of a web site map for the virtual marketplace of FIG. 4.

### DETAILED DESCRIPTION OF THE PREFERRED EMBODIMENTS

The following description of the preferred embodiment(s) is merely exemplary in nature and is in no way intended to limit the invention, its application, or uses.

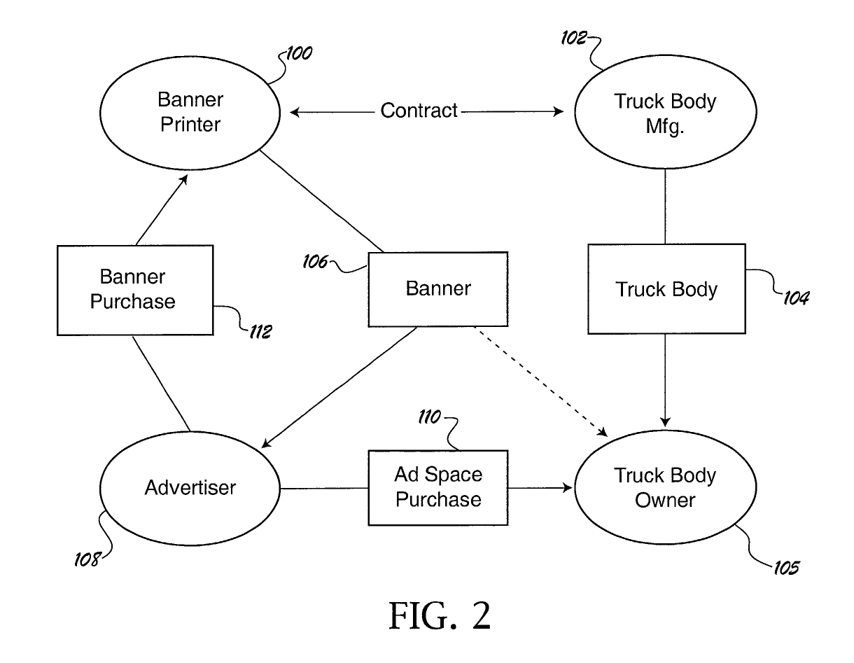

Referring to FIG. 2, an embodiment of the truck body banner advertising method of this invention is described. A banner printer 100 enters into an contractual arrangement with a truck body manufacturer 102 wherein the truck body manufacturer agrees to manufacturer its truck bodies 104 with the hardware necessary to affix banners 106 printed by banner printer 100 to the sides of truck bodies 104. The banner printer 100 agrees to pay truck body manufacturer 102 a share of the revenues that banner printer 100 receives for printing banners 106. In this regard, the arrangement between banner printer 100 and truck body manufacturer 102 can provide that banner printer 100 pay truck body manufacturer 102 a fixed amount for each banner (which could be a different fixed amount for differently priced banners) or a percentage of the sales price of the banner. Truck body manufacturer sells truck bodies 104 to truck body owners, such as truck body owner 105, who are illustratively truck freight companies, independent truckers, companies, truck rental companies, and the like.

An advertiser 108 purchases at 110 ad space from truck body owner 105 to have a banner 106 affixed to the side of a truck body 104 owned by truck body owner 105. In this context, the ad space is the side of a truck body 104 owned by truck body owner 105. Advertiser 108 purchases at 112 a banner 106 from banner printer 100. Banner printer 100 prints banner 106, affixes mounting hardware to it that corresponds to the mounting hardware on truck body 104, and delivers banner 106 to advertiser 108 or to truck body owner 105. Advertiser 108 pays banner printer 100 for the banner 106 and banner printer 100 in turn shares a portion of this revenue with truck body manufacturer 102.

Advertiser 108 could be a company that is running the banner advertisement or an advertising agency acting on behalf of the company that is running the banner advertisement.

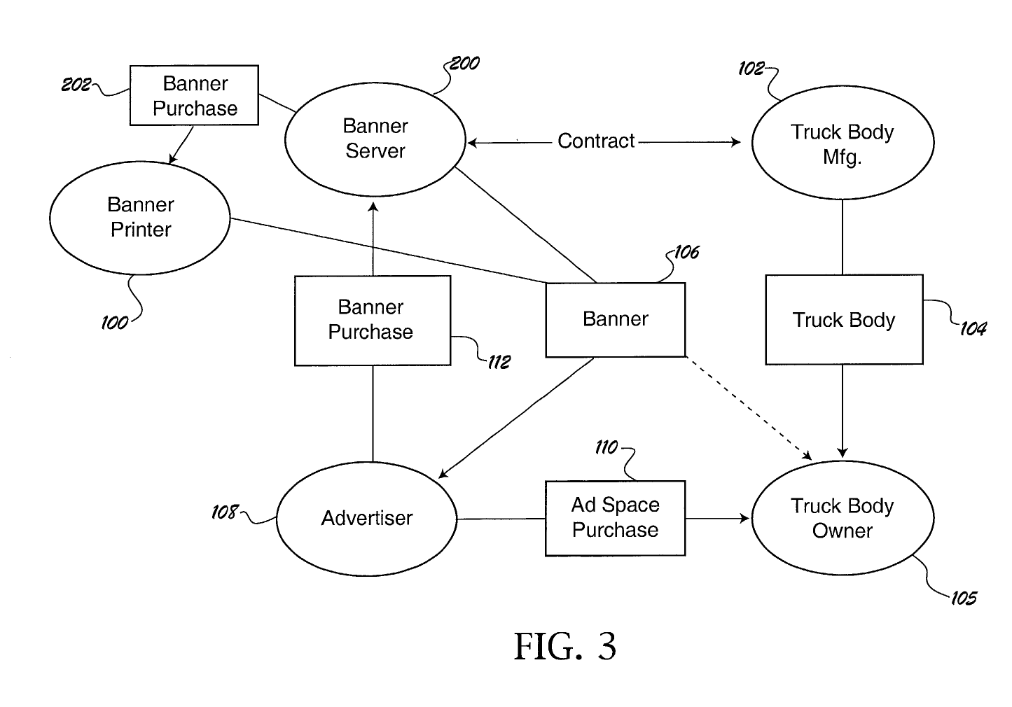

Referring to FIG. 3, a variation of the business method shown in FIG. 2 is described. The elements in FIG. 3 that are the same as the elements in FIG. 2 are identified with the same reference numbers. In the variation shown in FIG. 3, a banner seller 200, which could be an agent, enters into the contractual arrangement with the truck body manufacturer 102 where banner seller 200 agrees to share a portion of the revenues it derives from sales of banners 106 in return for truck body manufacturer 102 agreeing to manufacture its truck bodies with the hardware necessary to affix banners 106. Banner seller 200 also takes orders for banners 106 from advertiser 108, arranges to have the banners 106 delivered, and purchases the printing of banners 106 from banner printer 100. In another variation, advertiser 108 would be the entity that enters into the contractual arrangement with truck body manufacturer 102, purchases the printing of banners 106 from banner printer 100 and arranges for the delivery of banners 106.

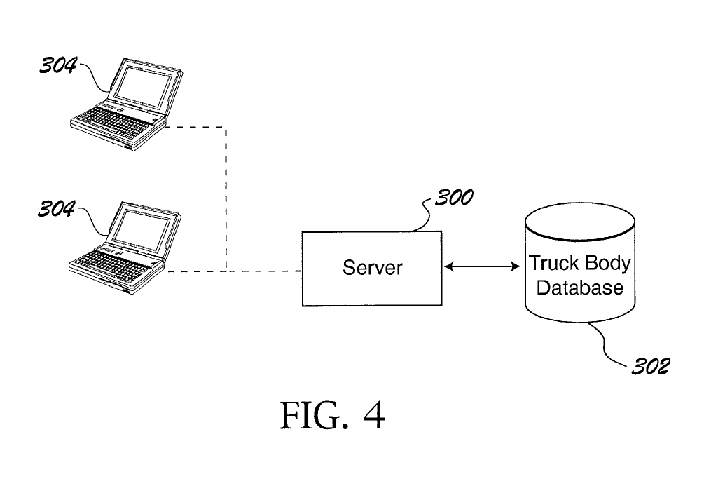

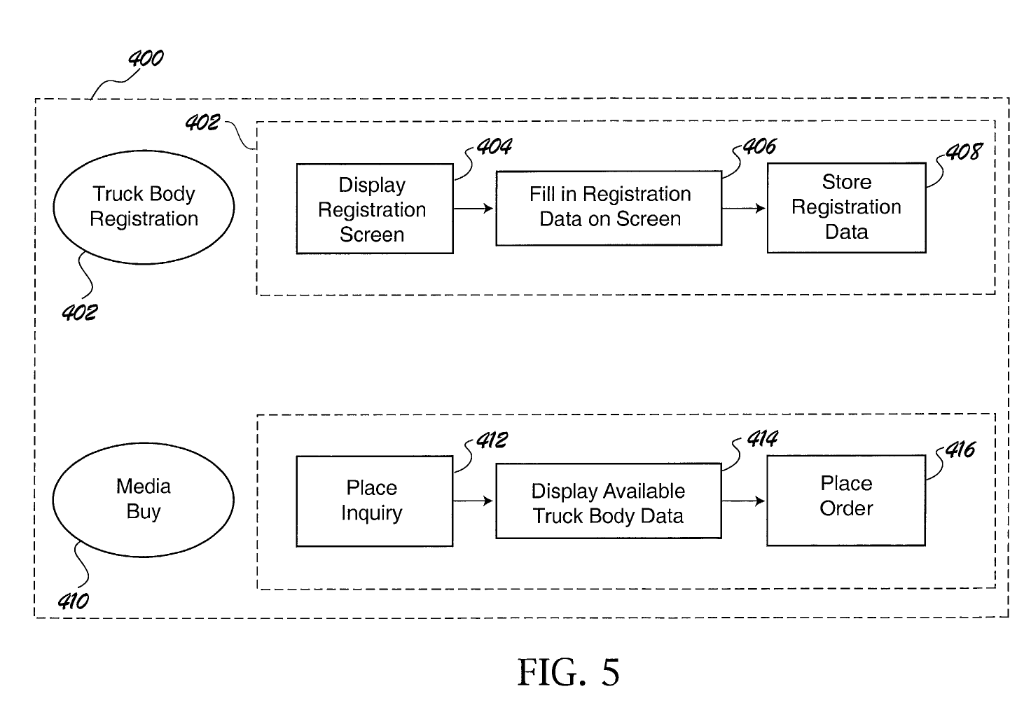

Referring to FIGS. 4 and 5, a virtual marketplace method embodiment of this invention is described. A server 300 hosting a virtual marketplace web site 400 is coupled to a truck body database 302. Truck body database 302 is a database of truck bodies that have the hardware necessary to affix banners 106 (FIG. 2) that have been registered by their truck body owners 105 (FIG. 2) as discussed below. Database 302 illustratively contains data about the truck body owner (such as name, address and contact information), data about the truck body (type, door height, door width from seal to seal, number of panels, height of each panel, mfg. serial number), data pertaining to the geographic area that the truck body traverses, and data regarding the dealer who sold the truck body. The geographic area can be the city where the truck body owner is located, if that truck body is only used within that city, a geographic region if the truck body is used within that geographic region, a route or routes if that truck body is typically used for that route or routes, or the entire country if that truck body is so used.

Server 300 is an Internet enabled server that allows truck body owners 105, and media buyers, such as advertisers 108, to access virtual marketplace web site 400, such as by using computers 304, via the Internet and register the truck bodies 104, determine what truck bodies 104 have been made available for banner advertising, and purchase advertising space on truck bodies 104.

With reference to FIG. 5, when a truck body owner 105 of a truck body 104 having the hardware necessary for affixing banners 106 decides to make that truck body 104 available for banner advertising, truck body owner 105 accesses virtual market place web site 400, such as by using a computer 304 (FIG. 4) via the Internet and registers that truck body 106 at 402. Truck body registration 402 is shown in more detail in dashed line block 402 in FIG. 5. Truck body registration 402 displays a registration screen at 404 that has blanks for the registration data discussed above. Truck body owner 105 fills in these blanks with the data at 406 and at 408, the registration data is stored in truck body database 302 (FIG. 4).

When an advertiser 108, or other media buyer, decides to purchase banner advertising space on a truck body 106 and wants to determine what truck bodies 106 have been made available for banner advertising, advertiser 108 or other media buyers accesses media buy 410 of web site 400, such as by using a computer 304, via the Internet. Media buy 410 is shown in more detail in the dashed block 410 in FIG. 5. At 412, advertiser 108 or other media buyer places an inquiry regarding what truck bodies 106 have been made available for banner advertising, preferably via an inquiry screen provided on web site 400. The inquiry may include inquiries regarding the type of truck body and its geographic area, or be limited in this regard. Media buy 410 accesses truck body database 302 (FIG. 4) and displays information responsive to the inquiry at 414 on a results screen on web site 400. The advertiser 108 or other media buyer decides whether to submit an order for banner advertising on one or more truck bodies and if it decides to do so, places the order at 416, preferably via an order screen provided on web site 400. If advertiser 108 or other media buyer submits an order, then advertiser 108 or other media buyer and the truck body owner 105 then negotiate regarding the purchase of the banner advertising on that truck body 104. Alternatively, web site 400 notifies truck body owner 105 of the desire of a media buyer to purchase banner advertising on a truck body 104 owned by that truck body owner 105 and the truck body owner 105 can, if it chooses, contact the media buyer to negotiate the sale of the banner advertising on the truck body 104. Once the order is closed, an entry would preferably be submitted to truck body database 302 indicating that banner advertising has been booked to run on the particular truck body(ies) during time period bought by the advertiser 108.

Web site 400 can alternatively provide for automatic order closure. When the truck body owner 105 registered the truck body 106, web site 400 would provide the option for automatic order closure. If the truck body owner 105 selected that option, then a price for the banner advertising on that truck body would be established and when the advertiser 108 decides to place the order, the order is placed for that price and no negotiation between the truck body owner 105 and advertiser 108 need occur. Upon order closure, an entry would be submitted to truck body database 302 indicating that banner advertising has been booked to run on the particular truck body(ies) during time period bought by the advertiser 108.

By maintaining information regarding when banner advertising has been booked to run on truck bodies 106 in database 302, it can be determined whether a particular truck body is available for banner advertising during a particular time period.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of sharing revenues generated from sales of banners that are affixed to truck bodies, comprising the steps of:
(a) a manufacturer of the truck bodies manufacturing the truck bodies with mounting hardware for the banners;
(b) the manufacturer receiving a share of revenues from sales by a banner seller of banners to be affixed to truck bodies made by the manufacturer with the mounting hardware for the banners.

2. The method of claim 1 and further including the step of affixing to the banners mounting hardware that mates with the mounting hardware on the track bodies made by the manufacturer.

3. A method of sharing revenues generated from printing banners that are affixed to truck bodies, comprising the steps of:
(a) a manufacturer of truck bodies manufacturing the truck bodies with mounting hardware for the banners;
(b) a printer printing the banners and sharing with the manufacturer a portion of the revenues the printer receives for printing the banners.

4. The method of claim 3 and further including the step of affixing to the banners mounting hardware that mates with the mounting hardware on the truck bodies.

5. A method of facilitating banner advertising on truck bodies, the banner advertising comprising affixing banners to the sides of the truck bodies, the method comprising the steps of:
(a) storing in a database information identifying owners of truck bodies having mounting hardware for the banners who have agreed to make their truck bodies available for banner advertising and information concerning those truck bodies;
(b) accessing the database to identify one or more truck bodies which have been made available for banner advertising.

6. The method of claim 5 wherein the information stored in the database concerning the truck bodies includes information concerning time periods during which banner advertising has been booked to run on truck bodies and the method further includes the step of determining from that information concerning the time periods during which banner advertising has been booked to run on truck bodies whether a truck body is available for banner advertising for a particular time period.

7. The method of claim 5, and further including the step of establishing an Internet accessible web site, the step of storing in the database information identifying the owners of truck bodies who have agreed to make the truck bodies available for banner advertising and information concerning those truck bodies including providing a registration screen on the web site for the truck owners to complete to provide such information and storing the information provided by the truck body owners on the registration screen in the database.

8. The method of claim 7 wherein the step of accessing the database to identify at least one of the truck bodies on which to affix a banner includes providing a inquiry screen on the web site by which an inquiry can be submitted and the step of determining the one or more truck bodies that have been made available for banner advertising includes doing so in response to the inquiry and displaying results of the determination on a results screen on the web site.

9. A method of facilitating banner advertising on truck bodies, the banner advertising comprising affixing banners to the sides of the truck bodies, the method comprising:
(a) establishing an Internet accessible web site having a registration screen, an inquiry screen, and a results screen;
(b) truck body owners who wish to make truck bodies that they own available for banner advertising registering their truck bodies via the registration screen by filling in on the registration screen registration data relating to the truck bodies;
(c) storing the information provided by the truck body owners via the registration screen in a database; and
(d) media buyers who wish to run a banner advertisement on truck bodies accessing the database via the inquiry screen to determine of truck bodies that have been made available for banner advertising.

10. The method of claim 9, and further including the step of when banner advertising is booked for a truck body, storing in the database information concerning time periods that the banner advertising has been booked to run on that truck body, the step of determining availability of truck bodies for banner advertising including determining whether the truck bodies are available for banner advertising for particular time periods based on the information stored in the database concerning time periods that banner advertising has been booked to run on the truck bodies.

11. The method of claim 10 and further including the step of providing an order screen on the web site for media buyers to use to place orders for banner advertising on truck bodies.
